(19) United States
(12) Patent Application Publication
(10) Pub. No.: US 2023/0409867 A1
(43) Pub. Date: Dec. 21, 2023

(54) JOINT TRAINING OF NETWORK ARCHITECTURE SEARCH AND MULTI-TASK DENSE PREDICTION MODELS FOR EDGE DEPLOYMENT

(71) Applicant: Mineral Earth Sciences LLC, Mountain View, CA (US)

(72) Inventors: Chunfeng Wen, Santa Clara, CA (US); Yueqi Li, San Jose, CA (US); Zhiqiang Yuan, San Jose, CA (US); Minh Thanh Vu, San Francisco, CA (US); Yanqi Zhou, Mountain View, CA (US)

(21) Appl. No.: 17/841,009

(22) Filed: Jun. 15, 2022

(51) Int. Cl. G06N 3/04; G06N 3/063; G06K 9/62; H04L 41/16

(52) U.S. Cl. CPC G06N 3/04; G06N 3/063; G06K 9/6265; H04L 41/16

(57) ABSTRACT

Implementations are described herein for performing joint optimization of multi-task learning of dense predictions (MT-DP) and hardware-aware neural architecture search (NAS). In various implementations, a set of tasks to be performed using a resource-constrained edge computing system may be determined. Based on a base multi-task dense-prediction (MT-DP) architecture template, the set of tasks, and a plurality of hardware-based constraints of a target edge computing system, a network architecture search (NAS) may be used to sample candidate MT-DP architecture(s) from a search space of neural network architecture components. Each sampled candidate MT-DP architecture may include a distinct assembly of sampled neural network architecture components applied to the base MT-DP architecture template. Image data may be processed using the candidate MT-DP architecture(s) to determine performance metrics. These performance metrics may be used to jointly train the MT-DP architecture(s) and/or the NAS.

### BACKGROUND

Computer vision has been increasingly integrated with edge applications such as autonomous driving, mobile vision, robotics, and precision agriculture. In many of these edge applications, pixel-level dense prediction tasks such as semantic segmentation and/or depth estimation can play a critical role. For example, autonomous vehicles use semantic segmentation and depth information to detect lanes, avoid obstacles, and locate their own positions. In precision agriculture, the output of pixel-level dense prediction tasks can be used for crop analysis, yield prediction, as well as for in-field robot navigation.

However, edge computing devices typically are more constrained in terms of computational resources than central computing resources, such as large numbers of server computers forming what is often referred to as the “cloud.” Consequently, designing fast and efficient dense prediction models for edge devices is challenging. Pixel-level predictions such as semantic segmentation and depth estimation are more computationally expensive than some image-level or instance-level/object-level vision tasks, such as image classification or object detection. This is because after encoding the input images into lower-dimensioned representations (e.g., low-spatial resolution features), the lower-dimensioned representations may be upsampled to produce high-resolution output masks. Depending on the specific dense prediction models, hardware, and target resolution, dense estimation can be an order of magnitude slower than sparser vision tasks. These challenges may be intensified for edge tensor applications on platforms powered by edge tensor processing units, or “Edge TPUs,” due to the limited computational resources.

In addition, developing dense prediction models for edge environments is costly and difficult to scale given the heterogeneous hardware found on edge computing devices. In particular, edge applications may be deployed on a variety of different platforms, such as cellphones, robots, unmanned aerial vehicles (“UAVs” or “drones”), modular sensor packages, and more. Unfortunately, machine learning models designed for one hardware platform do not necessarily generalize to other hardware platforms.

### SUMMARY

Implementations are described herein for performing joint training/optimization of multi-task dense predictions (MT-DP) and hardware-aware neural architecture search (NAS) models. Learning these two components jointly may benefit not only the development of MT-DP models for the edge, but may also benefit the development of NAS models. Existing methods for multi-task dense predictions mostly focus on learning how to share a fixed set of layers, not whether the layers themselves are optimal for MT-DP. Moreover, existing MT-DP techniques are typically used to train large models powered by powerful computational resources, such as graphics processing units (GPUs), and are not readily suitable for edge applications. Similarly, existing NAS techniques often focus on either tasks that are simpler than MT-DP, such as classification or simpler single-task training setup. By contrast, jointly learning MT-DP and NAS models as described herein leverages the strengths of both techniques to address the aforementioned issues simultaneously, resulting an improved approach to efficient dense predictions for edge computing devices.

In various implementations, a method implemented using one or more computing devices may include: obtaining a set of tasks to be performed using a resource-constrained edge computing system; based on a base multi-task dense-prediction (MT-DP) architecture template, the set of tasks, and a plurality of hardware-based constraints of the edge computing system, and using a network architecture search (NAS), sampling one or more candidate MT-DP architectures from a search space of neural network architecture components, wherein each sampled candidate MT-DP architecture comprises a distinct assembly of sampled neural network architecture components applied to the base MT-DP architecture template; and processing image data using the one or more candidate MT-DP architectures to determine one or more performance metrics for each of the one or more candidate MT-DP architectures.

In various implementations, the method may further include training the NAS (e.g., by training a machine learning model used by the NAS, or by training another algorithm employed by the NAS) based on the one or more performance metrics for each of the one or more candidate MT-DP architectures. In various implementations, the method may further include selecting and deploying, on the edge computing system, one or more of the candidate MT-DP architectures based on one or more of the performance metrics.

In various implementations, the method may further include partially training the one or more candidate MT-DP architectures to a degree short of convergence, wherein the one or more performance metrics are determined from the partially-trained candidate MT-DP architectures. In various implementations, at least one of the tasks may include pixel-wise depth estimation, and the partially training is performed using both mean absolute error (MAE) and mean relative error (MRE).

In various implementations, each of the neural network architecture components in the search space may be a neural network layer having one or more layer parameters. In various implementations, the one or more layer parameters may include a layer type selected from inverted bottleneck (IBN) and fused-MN. In various implementations, the one or more layer parameters may include a kernel size, an output channel multiplier, stride, and/or an expansion ratio.

In another aspect, a method may be implemented using one or more processors and may include: obtaining a plurality of images capturing crops growing in an agricultural plot; processing the plurality of images using one or more candidate multi-task dense-prediction (MT-DP) machine learning models to perform a plurality of agricultural prediction tasks, including one or more agricultural prediction tasks that generate pixel-level predictions for the plurality of images, wherein each of the one or more MT-DP machine learning models was assembled using neural network layers sampled from a search space of neural network layers having different parameters using a network architecture search (NAS) machine learning model; and operating one or more agricultural vehicles in the agricultural plot based on the pixel-level predictions for the plurality of images.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be employed in accordance with various implementations.

FIG. 2A schematically depicts a high-level overview of how various techniques described herein are implemented, in accordance with various implementations.

FIG. 2B schematically depicts examples of how network architectures can be sampled, including how neural network layers can be sampled, in accordance with various implementations.

FIG. 3 schematically depicts an example of how aspects of the present disclosure may be practiced, in accordance with various implementations.

FIG. 4A and FIG. 4B schematically depict examples of different neural network layers that may be included in search spaces that are sampled using techniques described herein, in accordance with various implementations described herein.

FIG. 5 is a flowchart of an example method in accordance with various implementations described herein.

FIG. 6 schematically depicts an example architecture of a computer system.

### DETAILED DESCRIPTION

Implementations are described herein for performing joint training/optimization of multi-task dense predictions (MT-DP) and hardware-aware neural architecture search (NAS) models. Learning these two components jointly may benefit not only the development of MT-DP models for the edge, but may also benefit the development of NAS models. Existing methods for multi-task dense predictions mostly focus on learning how to share a fixed set of layers, not whether the layers themselves are optimal for MT-DP. Moreover, existing MT-DP techniques are typically used to train large models powered by powerful computational resources, such as graphics processing units (GPUs), and are not readily suitable for edge applications. Similarly, existing NAS techniques often focus on either tasks that are simpler than MT-DP, such as classification or simpler single-task training setup. By contrast, jointly learning MT-DP and NAS models as described herein leverages the strengths of both techniques to address the aforementioned issues simultaneously, resulting an improved approach to efficient dense predictions for edge computing devices.

Furthermore, although both mean absolute error (MAE) and mean relative error (MRE) are often used to evaluate depth prediction, existing MT-DP models are typically only trained with the MAE loss function. This may lead to an undesirably large variance in the relative depth error, which can significantly and negatively affect the accuracy of MT-DP evaluation as misleading improvement (or degradation) can manifest purely because of random fluctuation in the relative error. Accordingly, in various implementations, MRE loss can also be used during training of MT-DP models, in addition to MAE loss, as an easy-to-adopt but surprisingly effective augmentation to simultaneously improve prediction accuracy and reduce negative effects of relative error noise.

In some instances, the joint training of MT-DP and NAS models for edge deployment may be implemented as follows. A set T of N (positive integer) tasks {T₁, T₂, . . . T_{N}} to be performed using the MT-DP on a resource-constrained edge computing system may be determined. These tasks may vary from domain to domain. In the agricultural domain, for instance, tasks such as depth perception, phenotypic segmentation, plant trait inference, crop yield prediction, etc. may be performed by a MT-DP model. In addition, a plurality of hardware-based constraints of the target edge computing system may be identified. These hardware-based constraints may include, for instance, inference latency, chip area, energy usage, etc.

In some implementations, an existing MT-DP architecture template may be used as a basis for NAS. Based on this base MT-DP architecture template, as well as the set of tasks and the plurality of hardware-based constraints of the target edge computing system, a NAS module may sample one or more candidate MT-DP architectures from a search space of neural network architecture components. Each sampled candidate MT-DP architecture may include a distinct assembly of sampled neural network architecture components that are applied to (e.g., used to modify or replace parts of) the base MT-DP architecture template.

In various implementations, the neural architecture components in the search space may include, for instance, neural network layers having various layer parameters. One layer parameter may be a layer type. A layer type may include, for instance, an inverted bottleneck (IBN) layer, a fused IBN layer, etc. In addition to a layer type, each neural network layer may have any number of other per-layer parameters, including but not limited to kernel size, output channel multipliers (e.g., {0.5, 0.75, 1.0, 1.5}), stride, and expansion ratios, to name a few.

The one or more candidate MT-DP architectures may then be used to process image data to determine one or more performance metrics of the one or more candidate MT-DP architectures, e.g., on an individual task basis or across the multiple tasks. Performance metrics for tasks such as semantic segmentation may include, for instance, mean intersection over union (mIoU) and pixel accuracy (PAcc). For depth prediction, mean absolute error (AbsE) and mean relative error (RelE) may be employed. For surface normal estimation, an angle distance error (MeanE) across all pixels, as well as the percentage of pixels with angle distances less than a threshold may be used. In some implementations, a single or unified evaluation score ΔT averaging over all relative gains ΔTᵢ of all tasks Tᵢ may be calculated.

In various implementations, the metrics may be used to train the NAS (e.g., a machine learning model or search method employed by the NAS) and/or to select the best candidate MT-DP model(s) for deployment at the edge. In the former case, the NAS may be trained based on the performance metrics. For example, in some implementations, the NAS search may be formulated as a multi-objective search with the goal of discovering optimal MT-DP model(s) with high accuracy for all tasks in T and low inference latency on specific edge computing systems. In some such implementations, the optimization may be expressed using the following Equation (1):

$${max}_{a ⊂ A} Rwd ( a , T , h , {ω}_{a}^{*} ) s . t {ω}_{a}^{*} = arg {min}_{{w}_{a}} Loss ( a , T , {w}_{a} ) ; Lat ( a , h ) \leq {l}_{h}$$

In Equation (1), a represents an architecture with weights wₐ sampled from the search space A, and h represents a target edge hardware. Rwd( ) is the objective or reward function and lₕ is the target edge latency dependent on the hardware and application domain.

In various implementations, a weighted product for the reward function Rwd( ) may be used to jointly optimize for the MT-DP models' accuracy and latency constrained by the hardware-based constraints mentioned previously. This may allow for flexible customization and encourage Pareto optimal solutions of MT-DP learning. In some implementations, inference latency Lat(a, h) as the main hardware-based constrained may be expressed in the following Equation (2):

$$Rwd ( a , T , h , {w}_{a} ) = {Acc ( a , T , {w}_{a} ) [ \frac{Lat ( a , h )}{{l}_{h}} ]}^{β} ; β = \{ \begin{matrix}p if Lat ( a , h ) \leq {l}_{h} \\ q otherwise\end{matrix}$$

In some implementations, the notion of pixel accuracy Acc( ) may be extended to MT-DP learning using a nested weighted product of metrics and tasks. Let Mᵢ={m_{i,1}, mᵢ₂, . . . m_{i,k}} be the set of metrics of interests for tasks Tᵢ. A multi-task pixel accuracy can be expressed using the following Equation (3):

$$Acc ( a , T , {w}_{a} ) = {[ {\prod }_{i} {m}_{i} ]}^{1 / N} with {m}_{i} = {[ {\prod }_{j} {m}_{i , j}^{{w}_{i , j}} ]}^{1 / {\sum }_{j} {w}_{i , j}}$$

This extended formulation is straightforward and scalable even when the number of tasks or metrics increases. Since a goal is to discover multi-task networks that can perform well across all tasks without bias to individual tasks, all task rewards may be treated equally many cases.

As noted previously, among the different dense prediction tasks, monocular depth estimation is commonly trained with MAE, e.g., the L1 loss function, and evaluated with both absolute and relative errors. However, there may be a significant amount of randomness in the relative error scores of such models. It has been observed that MRE scores particularly can fluctuate greatly to the point that it introduces random noise to the evaluation of multi-task models as one model can have significantly lower MRE (or higher) just by chance. This variation may be due to the indirect optimization of MRE via MAE loss. To reduce such noise and improve performance, in various implementations, MRE may be added explicitly as an additional loss for depth training, alongside MAE. Doing so may simultaneously stabilize and significantly improve MRE performance, without a significant negative effect on MAE score, given appropriate loss weighting.

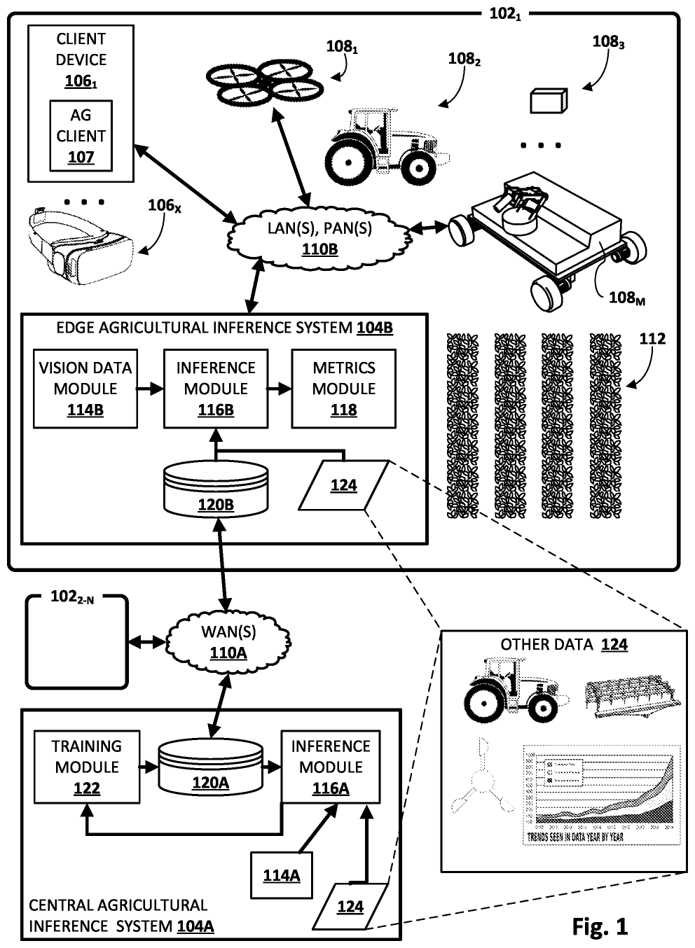

FIG. 1 schematically illustrates one example environment in which one or more selected aspects of the present disclosure may be implemented, in accordance with various implementations. The example environment depicted in FIG. 1 relates to the agriculture domain, which as noted previously is a beneficial domain for implementing selected aspects of the present disclosure. However, this is not meant to be limiting. Techniques described here may be useful in any domain in which MT-DP architectures are widely used at the edge, such as autonomous driving.

The environment of FIG. 1 includes a plurality of edge sites 102_{1-N} (e.g., farms, fields, plots, or other areas in which crops are grown) and a central agricultural inference system 104A. Additionally, one or more of the edge sites 102, including at least edge site 1021, includes an edge agricultural inference system 104B, a plurality of client devices 106_{1-X}, human-controlled and/or autonomous farm equipment 108_{1-M}, and one or more fields 112 that are used to grow one or more crops. Field(s) 112 may be used to grow various types of crops that may produce plant parts of economic and/or nutritional interest. These crops may include but are not limited to everbearing crops such as strawberries, tomato plants, or any other everbearing or non-everbearing crops, such as soybeans, corn, lettuce, spinach, beans, cherries, nuts, cereal grains, berries, grapes, sugar beets, and so forth.

One edge site 102₁ is depicted in detail in FIG. 1 for illustrative purposes. However, as demonstrated by additional edge sites 102_{2-N} , there may be any number of edge sites 102 corresponding to any number of farms, fields, or other areas in which crops are grown, and in which large-scale agricultural tasks such as harvesting, weed remediation, fertilizer application, herbicide application, planting, tilling, etc. are performed. Each edge site 102 may include the same or similar components as those depicted in FIG. 1 as part of edge site 102₁.

In various implementations, components of edge sites 1021-N and central agricultural inference system 104A collectively form a distributed computing network in which edge nodes (e.g., client device 106, edge agricultural inference system 104B, farm equipment 108) are in network communication with central agricultural inference system 104A via one or more networks, such as one or more wide area networks (“WANs”) 110A. Components within edge site 1021, by contrast, may be relatively close to each other (e.g., part of the same farm or plurality of fields in a general area), and may be in communication with each other via one or more local area networks (“LANs”, e.g., Wi-Fi, Ethernet, various mesh networks) and/or personal area networks (“PANs”, e.g., Bluetooth), indicated generally at 110B.

An individual (which in the current context may also be referred to as a “user”) may operate a client device 106 to interact with other components depicted in FIG. 1. Each client device 106 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) 106_{X} that provides an AR or VR immersive computing experience, a “smart” watch, and so forth. Additional and/or alternative client devices may be provided.

Central agricultural inference system 104A and edge agricultural inference system 104B (collectively referred to herein as “agricultural inference system 104”) comprise an example of a distributed computing network for which techniques described herein may be particularly beneficial. Each of client devices 106, agricultural inference system 104, and/or farm equipment 108 may include one or more memories for storage of data and software applications, one or more processors for accessing data and executing applications, and other components that facilitate communication over a network. The computational operations performed by client device 106, farm equipment 108, and/or agricultural inference system 104 may be distributed across multiple computer systems.

Each client device 106 and some farm equipment 108 may operate a variety of different applications that may be used, for instance, to obtain and/or analyze various agricultural inferences (real time and delayed) generated using machine learning models that are created as described herein. For example, a first client device 1061 operates an agricultural (AG) client 107 (e.g., which may be standalone or part of another application, such as part of a web browser) that may allow the user to, among other things, view various dense predictions made about field 112 using MT-DP models designed as described herein. Another client device 106_{X} may take the form of a HMD that is configured to render 2D and/or 3D data to a wearer as part of a VR immersive computing experience. For example, the wearer of client device 106_{X} may be presented with 3D point clouds (e.g., generated using MT-DP models described herein) representing various aspects of objects of interest, such as fruit/vegetables of crops, weeds, crop yield predictions, etc. The wearer may interact with the presented data, e.g., using HMD input techniques such as gaze directions, blinks, etc.

Individual pieces of farm equipment 108_{1-M} may take various forms. Some farm equipment 108 may be operated at least partially autonomously, and may include, for instance, an unmanned aerial vehicle 1081 that captures sensor data such as digital images from overhead field(s) 112. Other autonomous farm equipment may include a robot (not depicted) that is propelled along a wire, track, rail or other similar component that passes over and/or between crops, a wheeled robot 108_{M}, or any other form of robot capable of being propelled or propelling itself past crops of interest. In some implementations, different autonomous farm equipment may have different roles, e.g., depending on their capabilities. For example, in some implementations, one or more robots may be designed to capture data, other robots may be designed to manipulate plants or perform physical agricultural tasks, and/or other robots may do both. Other farm equipment, such as a tractor 1082, may be autonomous, semi-autonomous, and/or human-driven. Any of farm equipment 108 may include various types of sensors, such as vision sensors (e.g., 2D digital cameras, 3D cameras, 2.5D cameras, infrared cameras), inertial measurement unit (“IMU”) sensors, Global Positioning System (“GPS”) sensors, X-ray sensors, moisture sensors, barometers (for local weather information), photodiodes (e.g., for sunlight), thermometers, etc.

In some implementations, farm equipment 108 may take the form of one or more modular edge computing nodes 1083. An edge computing node 1083 may be a modular and/or portable data processing device and/or sensor package that may be carried through an agricultural field 112, e.g., by being mounted on another piece of farm equipment (e.g., on a boom affixed to tractor 1082 or to a truck) that is driven through field 112 and/or by being carried by agricultural personnel. Edge computing node 1083 may include logic such as processor(s), application-specific integrated circuits (ASICs), field-programmable gate arrays (FPGA), etc., configured with selected aspects of the present disclosure to capture and/or process various types of sensor data to make agricultural inferences using MT-DP models that are created using disclosed techniques.

In some examples, one or more of the components depicted as part of edge agricultural inference system 104B may be implemented in whole or in part on a single edge computing node 1083, across multiple edge computing nodes 1083, and/or across other computing devices, such as client device(s) 106. Thus, when operations are described herein as being performed by/at edge agricultural inference system 104B, or as being performed “in situ,” it should be understood that those operations may be performed by one or more edge computing nodes 108₃, and/or may be performed by one or more other computing devices at the edge 102, such as on client device(s) 106. In many cases, the MT-DP models that are generated as described herein—by using a NAS to sample candidate MT-DP architectures and then determining metrics for those candidate architectures—may be generated specifically for edge computing components such as modular edge computing nodes 108₃.

In various implementations, edge agricultural inference system 104B may include a vision data module 114B, an edge inference module 116B, and a metrics module 118. Edge agricultural inference system 104B may also include one or more edge databases 120B for storing various data used by and/or generated by modules 114B, 116B, and 118, such as vision and/or other sensor data gathered by farm equipment 108_{1-M}, agricultural inferences, MT-DP machine learning models that are created using techniques described herein, and so forth. In some implementations one or more of modules 114B, 116B, and/or 118 may be omitted, combined, and/or implemented in a component that is separate from edge agricultural inference system 104B.

In various implementations, central agricultural inference system 104A may be implemented across one or more computing systems that may be referred to as the “cloud.” Central agricultural inference system 104A may receive massive sensor data generated by farm equipment 108_{1-M} (and/or farm equipment at other edge sites 102_{2-N}) and process it using various techniques to make agricultural inferences. However, the agricultural inferences generated by central agricultural inference system 104A may be delayed, e.g., by the time required to physically transport portable data devices (e.g., hard drives) from edge sites 102_{1-N} to central agricultural inference system 104A, and/or by the time required by central agricultural inference system 104A to computationally process this massive data.

Agricultural personnel (e.g., farmers) at edge sites 102 may desire agricultural inferences, such as inferences about performance of an agricultural task, much more quickly than this. Moreover, farmers may value the privacy of their data and may prefer that their data not be sent to the cloud for processing. Accordingly, in various implementations, techniques described herein may be employed to leverage NAS to generate MT-DP machine learning models that are tailored towards computing hardware (e.g., TPUs) at the edge 102. By creating MT-DP machine learning models that are usable at the edge 102, various tasks associated with these models may be performed in situ at edge agricultural inference system 104B.

Central agricultural inference system 104A may include the same or similar components as edge agricultural inference system 104B. In some implementations, central database 120A may include one or more NAS models that are used, e.g., by inference module 116A, to sample candidate MT-DP machine learning models as described herein.

Referring back to edge agricultural inference system 104B, in some implementations, vision data module 114B may be configured to provide sensor data to edge inference module 116B. In some implementations, the vision sensor data may be applied, e.g., continuously and/or periodically by edge inference module 116B, as input across one or more MT-DP machine learning models (and other models if present) stored in edge database 120B to generate inferences about one or more plants in the agricultural field 112. Inference module 116B may process the inference data in situ at the edge using one or more of the MT-DP machine learning models stored in database 120B. In some cases, one or more of these MT-DP machine learning model(s) may be stored and/or applied directly on farm equipment 108, such as edge computing node 1083, to make dense predictions about plants of the agricultural field 112.

Various types of NAS and MT-DP machine learning models may be applied by inference modules 118A/B to perform a variety of different dense prediction tasks. These various NAS and/or MT-DP machine learning models may include, but are not limited to, various types of recurrent neural networks (RNNs) such as long short-term memory (LSTM) or gated recurrent unit (GRU) networks, transformer networks such as the Bidirectional Encoder Representations from Transformers (BERT) transformer, feed-forward neural networks, convolutional neural networks (CNNs), support vector machines (SVMs), random forests, decision trees, etc. Additionally, various types of machine learning models may be used to generate image embeddings that are applied as input across the various MT-DP machine learning models.

In some implementations, other data 124 may be applied as input across these MT-DP models besides sensor data or embeddings generated therefrom. Other data 124 may include, but is not limited to, historical data, weather data (obtained from local weather sensors or other sources), data about chemicals and/or nutrients applied to crops and/or soil, pest data, crop cycle data, previous crop yields, farming techniques employed, cover crop history, and so forth. Weather data may be obtained from various sources in addition to or instead of sensor(s) of farm equipment 108, such as regional/county weather stations, etc. In implementations in which local weather and/or local weather sensors are not available, weather data may be extrapolated from other areas for which weather data is available, and which are known to experience similar weather patterns (e.g., from the next county, neighboring farms, neighboring fields, etc.).

Metrics module 118 may be configured to determine one or more performance metrics for one or more candidate MT-DP architectures that are assembled using NAS techniques described herein. As mentioned previously, performance metrics for tasks such as semantic segmentation may include, for instance, mean intersection over union (mIoU) and pixel accuracy (PAcc). For depth prediction, mean absolute error (AbsE) and mean relative error (RelE) may be employed. For surface normal estimation, an angle distance error (MeanE) across all pixels, as well as the percentage of pixels with angle distances less than a threshold may be used. In some implementations, a single or unified evaluation score ΔT averaging over all relative gains ΔTᵢ of all tasks Tᵢ may be calculated. While metrics module 118 is depicted in FIG. 1 as part of edge agricultural inference system 104B, in various implementations, metrics module 118 may be implemented in whole or in part elsewhere, such as on central agricultural inference system 104A.

Training module 122 may be configured to train the NAS (e.g., a machine learning model or algorithm employed thereby) and/or MT-DP machine learning models based on metrics generated by metrics module 118. In some instances, training module 122 may be configured to utilize one or more of Equations 1-3 described previously.

In this specification, the term “database” and “index” will be used broadly to refer to any collection of data. The data of the database and/or the index does not need to be structured in any particular way and it can be stored on storage devices in one or more geographic locations. Thus, for example, database(s) 120A and 120B may include multiple collections of data, each of which may be organized and accessed differently.

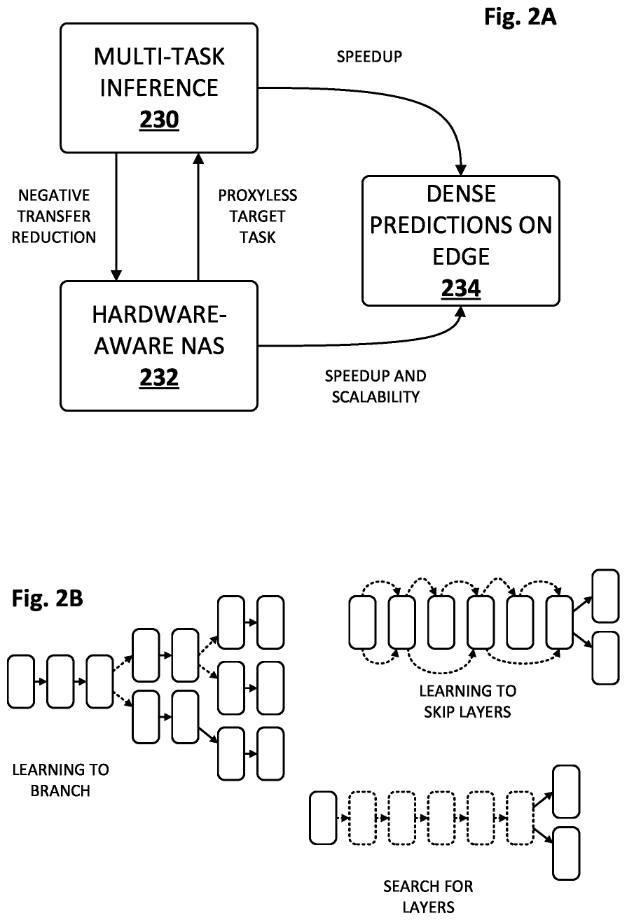

FIG. 2A schematically depicts, at a high level, how various techniques described herein leverage the joint learning of MT-DP and hardware-aware NAS to both complement each other and to produce improved pixel-level predictions on edge platforms. Three blocks are depicted representing the following processes: multi-task learning 230, hardware-aware NAS 232, and dense predictions on the edge 234.

Conventional techniques for developing and training MT-DP machine learning models often suffer from performance degradation known as “negative transfer.” As shown in FIG. 2A, joint learning of multi-task learning 230 and hardware-aware NAS 232 reduces this negative transfer, and also removes a proxy target and the corresponding assumption that neural architectures that are good at individual tasks can also be optimal for multi-task learning. In particular, the multi-task learning 230 coupled with the hardware-aware NAS 232 both speeds up dense predictions on the edge and makes designing MT-DP machine learning models more scalable across heterogeneous edge hardware.

FIG. 2B schematically depicts examples of how NAS may be applied to design neural network architectures. One option is referred to in FIG. 2B as “learning to branch,” and involves using NAS to select which branches (dashed arrows in FIG. 2B) to implement between layers. Another option is referred to in FIG. 2B as “learning to skip layers,” and involves using NAS to select when particular layers can be skipped or not, as indicated by the dashed arrows. A third option, which is leveraged by implementations described herein, is called “search for layers.” This third option involves using NAS to sample from a search space that includes neural network architecture components. These neural network architecture components may include, for instance, different types of neural network layers and/or layers having different parameters. These sampled neural network architecture components may be assembled into a candidate MT-DP architecture.

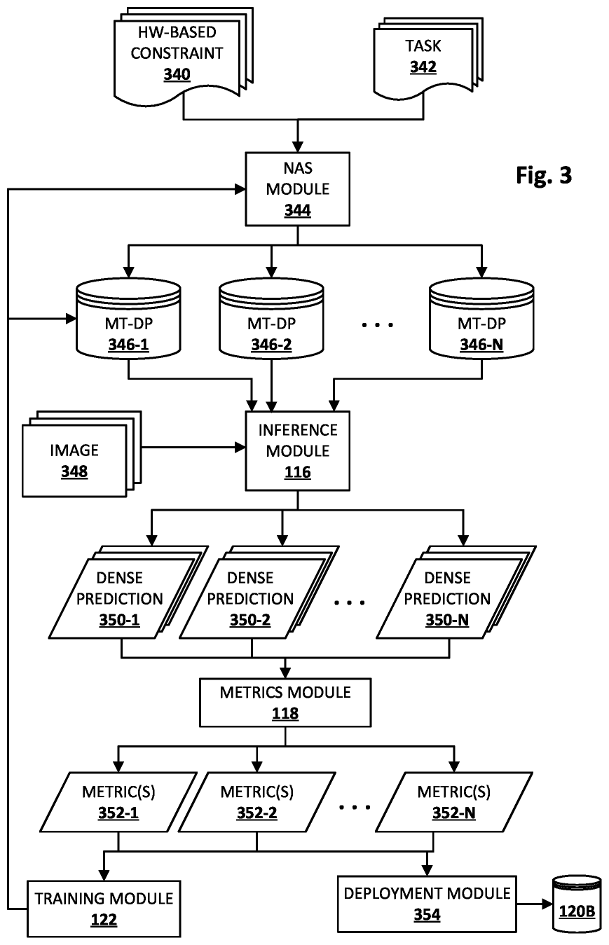

FIG. 3 schematically depicts an example of how techniques described herein may be implemented, in accordance with various implementations. Starting at top left, one or more edge hardware-based constraints 340 associated with one or more edge computing devices (e.g., 108_{1-M}) may be identified. As noted previously, these hardware-based constraints may include, for instance, inference latency, chip area, energy usage, etc.

Additionally, a plurality of tasks 342 that are to be performed by an MT-DP machine learning model are also identified. These tasks may vary depending on the domain (e.g., agriculture versus autonomous driving). In some implementations, these tasks may include semantic segmentation to identify various objects. In the agricultural domain, for instance, tasks such as depth perception, phenotypic segmentation, plant trait inference, crop yield prediction, etc. may be performed by a MT-DP model. In the autonomous driving context, segmentation and/or depth prediction tasks such as identification of lanes, traffic signals and/or signs, pedestrians, other vehicles, etc. may be performed by a MT-DP model.

NAS module 344 (e.g., implemented as part of central inference module 116A) may be used to process hardware-based constraints 340 and tasks 342 to perform, for instance, multi-trial search or one-shot, differential search. In some implementations, NAS module 344 may also process aspects of a base MT-DP architecture template. In some implementations, the base MT-DP architecture template may be selected to be well-suited for execution on edge computing resources. For example, in some implementations, the base MT-DP architecture template may include an EfficientNet backbone and weighted bi-directional feature pyramid network (BiFPN) fusion modules.

Based on this processing, NAS module 344 may generate (e.g., sample) a plurality of candidate MT-DP architectures 346-1 to 346-N. These candidate MT-DP architectures 346-1 to 346-N may include various types of neural networks and/or layers thereof, such as CNNs, feed-forward neural networks, recurrent neural networks (including LSTM, GRU, etc.), transformer networks, etc. They may be sampled from a search space that includes, for instance, different options of neural network architecture components (e.g., different types of layers, or layers having different parameters). NAS module 344 may implement various types of searching, such as multi-trial search or on-short differentiable search.

Inference module 116 (e.g., 116A via simulation) may then use candidate MT-DP architectures 346-1 to 346-N to process images 348 to generate, respectively, sets of dense predictions 350-1 to 350-N. Each of these sets of dense predictions 350-1 to 350-N may include, for instance, pixel-wise semantic segmentations, depth predictions, etc. Sets of dense predictions 350-1 to 350-N and/or other factors, such as time required to generate these inferences, may be analyzed by metrics module 118 to determine, for candidate MT-DP architectures 346-1 to 346-N, corresponding metrics 352-1 to 352-N.

In some implementations, metrics 352-1 to 352-N may be used by training module 122 to train one or both of candidate MT-DP architectures 346-1 to 346-N and NAS module 344. For example, training module 122 may partially train candidate MT-DP architectures 346-1 to 346-N to a degree short of convergence using labeled training data. An advantage of training candidate MT-DP architectures 346-1 to 346-N short of convergence is that it is possible to determine rough (e.g., “good enough”) metrics (e.g., latency, accuracy) of each candidate MT-DP architecture 346 without expending the considerable time and/or computational resources necessary to fully train any of these models to convergence. In some implementations, a cycle-accurate (i.e., emulating a target edge device) simulator may be used to estimate metrics of candidate MT-DP architectures 346-1 to 346-N.

Once partially trained, in some implementations, metrics module 118 may identify the “best” MT-DP machine learning model based on factors such as pixel accuracy and/or latency. Based on the metrics 352-1 to 352-N and/or the selected “best” candidate MT-DP machine learning model 346, training module 122 may train NAS module 344 using techniques such as back propagation, gradient descent, cosine annealing, etc. Additionally or alternatively, in some implementations, the selected “best” candidate MT-DP machine learning model 346 may be deployed, e.g., by a deployment module 354, to edge database 120B so that it can be applied by edge computing devices. In some implementations, the selected “best” candidate MT-DP machine learning model 346 may first be trained further towards convergence prior to this deployment.

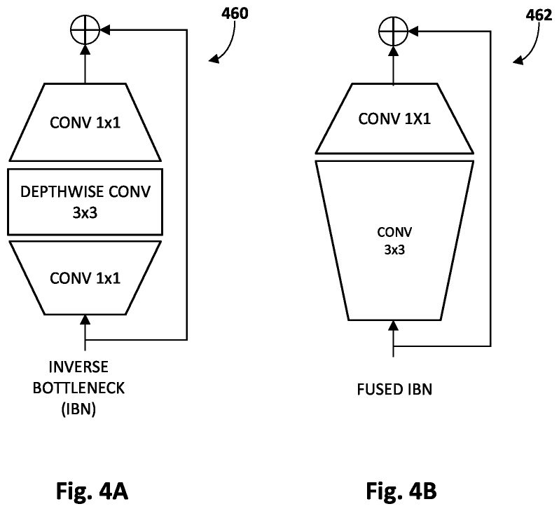

FIG. 4A depicts an example inverse bottleneck (IBN) neural network component 460 that may be sampled, e.g., by NAS module 344, from a search space. This example component 460 includes a 3×3 depth-wise convolution layer sandwiched between 1×1 convolution layers. FIG. 4B depicts an example fused IBN 462 that may be sampled, e.g., by NAS module 344, from a search space. It includes a 3×3 convolution layer and a 1×1 convolution layer. Despite inciting more trainable parameters, fused-IBN neural network component 462 can potentially offer better efficiency on edge devices if strategically placed, e.g. via sampling using NAS module 344. One possible reason is that industry accelerators are better tuned for regular convolution than their depth-wise counterparts, e.g. resulting in 3× speedup for certain tensor shapes and kernel dimensions.

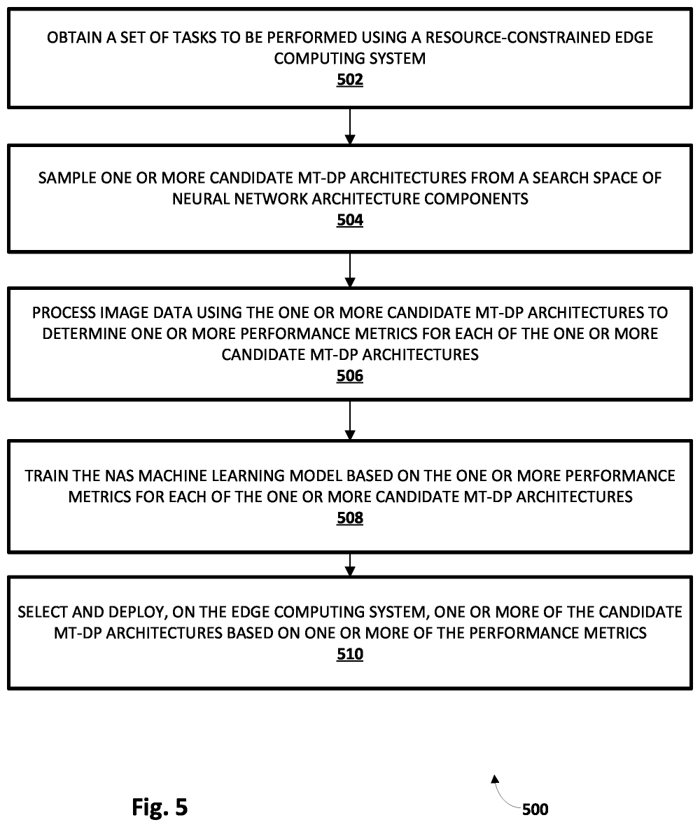

FIG. 5 illustrates a flowchart of an example method 500 for practicing selected aspects of the present disclosure. The operations of FIG. 5 can be performed by one or more processors, such as one or more processors of the various computing devices/systems described herein, such as by agricultural inference system 104. For convenience, operations of method 500 will be described as being performed by a system configured with selected aspects of the present disclosure. Other implementations may include additional operations than those illustrated in FIG. 5, may perform step(s) of FIG. 5 in a different order and/or in parallel, and/or may omit one or more of the operations of FIG. 5.

At block 502, the system may obtain a set of tasks to be performed using a resource-constrained edge computing system. Examples of these tasks were described previously. These tasks are represented in Equations 1-3 as a set T of N (positive integer) tasks {T₁, T₂, . . . T_{N}}.

Based on a base MT-DP architecture template (e.g., EfficientNet), the set of tasks obtained at block 502, and a plurality of hardware-based constraints of a target edge computing system, at block 504, NAS module 344 may sample one or more candidate MT-DP architectures from a search space of neural network architecture components. In various implementations, each sampled candidate MT-DP architecture may take the form of a distinct assembly of sampled neural network architecture components applied to the base MT-DP architecture template.

At block 506, the system, e.g., by way of inference module 116 and/or metrics module 118, may process image data using the one or more candidate MT-DP architectures to determine one or more performance metrics for each of the one or more candidate MT-DP architectures. As noted previously, in some implementations, these candidate MT-DP architectures may be trained far enough towards convergence to determine rough or granular performance metrics that are “good enough” to judge the models' qualities, without requiring the considerable resources necessary for full training. Various techniques may be employed to partially train these MT-DP models (as well as to perform the training of block 508), such as gradient descent, back propagation, cosine annealing (e.g., cosine learning rate scheduler), etc.

In some implementations, at block 508, the system, e.g., by way of training module 122, may train the NAS (e.g., a machine learning model or a search algorithm employed thereby) based on the one or more performance metrics for each of the one or more candidate MT-DP architectures. In some implementations, one or more of Equations 1-3 may be used for this purpose.

Additionally or alternatively to block 508, in some implementations, at block 510, the system, e.g., by way of metrics module 118 and/or deployment module 354, may select and deploy, on the edge computing system, one or more of the candidate MT-DP architectures based on one or more of the performance metrics.

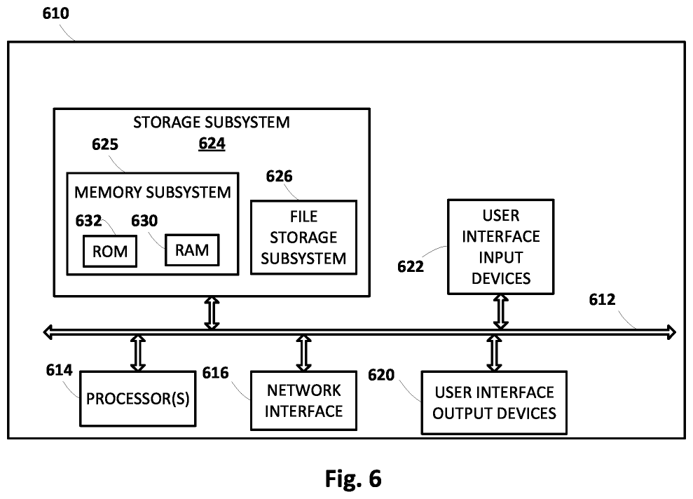

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In some implementations in which computing device 610 takes the form of a HMD or smart glasses, a pose of a user's eyes may be tracked for use, e.g., alone or in combination with other stimuli (e.g., blinking, pressing a button, etc.), as user input. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, one or more displays forming part of a HMD, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of method 500 described herein, as well as to implement various components depicted in FIGS. 1-4.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
obtaining a set of tasks to be performed using a resource-constrained edge computing system;
based on a base multi-task dense-prediction (MT-DP) architecture template, the set of tasks, and a plurality of hardware-based constraints of the edge computing system, and using a network architecture search (NAS), sampling one or more candidate MT-DP architectures from a search space of neural network architecture components, wherein each sampled candidate MT-DP architecture comprises a distinct assembly of sampled neural network architecture components applied to the base MT-DP architecture template; and
processing image data using the one or more candidate MT-DP architectures to determine one or more performance metrics for each of the one or more candidate MT-DP architectures.

2. The method of claim 1, further comprising training the NAS based on the one or more performance metrics for each of the one or more candidate MT-DP architectures.

3. The method of claim 1, further comprising selecting and deploying, on the edge computing system, one or more of the candidate MT-DP architectures based on one or more of the performance metrics.

4. The method of claim 1, further comprising partially training the one or more candidate MT-DP architectures to a degree short of convergence, wherein the one or more performance metrics are determined from the partially-trained candidate MT-DP architectures.

5. The method of claim 4, wherein at least one of the tasks comprises pixel-wise depth estimation, and the partially training is performed using both mean absolute error (MAE) and mean relative error (MRE).

6. The method of claim 1, wherein each of the neural network architecture components in the search space comprises a neural network layer having one or more layer parameters.

7. The method of claim 6, wherein the one or more layer parameters include a layer type selected from inverted bottleneck (IBN) and fused-MN.

8. The method of claim 6, wherein the one or more layer parameters include a kernel size.

9. The method of claim 6, wherein the one or more layer parameters include an output channel multiplier or stride.

10. The method of claim 6, wherein the one or more layer parameters include an expansion ratio.

11. A system comprising one or more processors and memory storing instructions that, in response to execution of the instructions, cause the one or more processors to:
obtain a set of tasks to be performed using a resource-constrained edge computing system;
based on a base multi-task dense-prediction (MT-DP) architecture template, the set of tasks, and a plurality of hardware-based constraints of the edge computing system, and using a network architecture search (NAS), sample one or more candidate MT-DP architectures from a search space of neural network architecture components, wherein each sampled candidate MT-DP architecture comprises a distinct assembly of sampled neural network architecture components applied to the base MT-DP architecture template; and
process image data using the one or more candidate MT-DP architectures to determine one or more performance metrics for each of the one or more candidate MT-DP architectures.

12. The system of claim 11, further comprising instructions to train the NAS based on the one or more performance metrics for each of the one or more candidate MT-DP architectures.

13. The system of claim 11, further comprising instructions to select and deploy, on the edge computing system, one or more of the candidate MT-DP architectures based on one or more of the performance metrics.

14. The system of claim 11, further comprising instructions to partially train the one or more candidate MT-DP architectures to a degree short of convergence, wherein the one or more performance metrics are determined from the partially-trained candidate MT-DP architectures.

15. The system of claim 4, wherein at least one of the tasks comprises pixel-wise depth estimation, and the one or more candidate MT-DP architectures are partially trained using both mean absolute error (MAE) and mean relative error (MRE).

16. The system of claim 11, wherein each of the neural network architecture components in the search space comprises a neural network layer having one or more layer parameters.

17. The system of claim 16, wherein the one or more layer parameters include a layer type selected from inverted bottleneck (IBN) and fused-MN.

18. The system of claim 16, wherein the one or more layer parameters include a kernel size or an output channel multiplier.

19. A method implemented using one or more processors and comprising:
obtaining a plurality of images capturing crops growing in an agricultural plot;
processing the plurality of images using one or more candidate multi-task dense-prediction (MT-DP) machine learning models to perform a plurality of agricultural prediction tasks, including one or more agricultural prediction tasks that generate pixel-level predictions for the plurality of images, wherein each of the one or more MT-DP machine learning models was assembled using neural network layers sampled from a search space of neural network layers having different parameters using a network architecture search (NAS); and
operating one or more agricultural vehicles in the agricultural plot based on the pixel-level predictions for the plurality of images.

20. The method of claim 19, further comprising jointly training the NAS and one or more of the candidate MT-DP machine learning models.
